(19) United States
(12) Patent Application Publication
(10) Pub. No.: US 2024/0149415 A1
(43) Pub. Date: May 9, 2024

(54) CHUCK KEY WITH HEX BIT

(71) Applicant: Robert P. White, Hertford, NC (US)

(72) Inventor: Robert P. White, Hertford, NC (US)

(21) Appl. No.: 18/502,925

(22) Filed: Nov. 6, 2023

Related U.S. Application Data
(60) Provisional application No. 63/382,494, filed on Nov. 4, 2022.

(51) Int. Cl. B25B 33/00

(52) U.S. Cl. CPC B25B 33/005

(57) ABSTRACT

A chuck key apparatus equipped with a male hex bit is described. A chuck key is present at a first end of a shaft, and the male hex bit is disposed on a second end of the shaft. The first end is in line with the second end. The apparatus facilitates manipulation of the jaws of a power tool rapidly and safely via connection of the apparatus to an impact driver or screwdriver via the male hex bit of the second end. A shaft connects the first end to the second end.

This application is a non-provisional patent application of provisional patent application No. 63/382,494, filed on Nov. 4, 2022, and priority is claimed thereto.

### FIELD OF THE PRESENT INVENTION

The present invention relates to the field of hand and power tools, and more specifically relates to an accessory tool configured to received by an impact driver or similar tool equipped with a female hex slot which exhibits a Chuck Key (Jacob's Chuck key) on a first end and a male hex bit on a second end. The apparatus facilitates the tightening and loosening of bits on power tools equipped with a chuck key receptacle (Chuck) via an impact driver or hand tool equipped with a female hex connector/receptacle.

### BACKGROUND OF THE PRESENT INVENTION

It is known that some power tools such as drill presses, corded drills, and similar bit-accepting devices are configured to accept a conventional “Chuck Key.” The chuck key is employed to tighten and/or loosen the grip the device has on the bit, and is used to facilitate the exchange of one bit for another in a secure and easy fashion.

Conventionally, chuck keys are T-shaped, with the cross section of the T-shape being used for leverage in the turning of the key during use. In the case of hand-held drills, especially those that are AC powered, the chuck key is often clipped to, or otherwise disposed in communication with the power cord to keep the chuck key handy.

Unfortunately, manipulating the chuck key by hand can be cumbersome, especially if the user is wearing gloves. It often requires consistent downward pressure to ensure that the chuck key remains within the female receptacle on the neck of the drill press or other tool while also pressure to turn the key itself, meshing the teeth of the key with the teeth present on the power tool. Further, if the drill is accidentally activated during manipulation of the chuck key, the teeth of the key and chuck can cause injury.

If there were a way in which an inline tool could be employed to manipulate the chuck key, such as an impact driver or inline screwdriver, use of the chuck key could be expedited and simplified. Further, if the chuck key were to be fashioned into the linear shape of a hex bit, the chuck key could securely be kept in a storage case with other hex bits, preventing the loss of the chuck key to ensure that it is easily found when needed. Likewise, if such a hex bit-equipped chuck key were employed, injuries from accidental drill activation could be avoided as the user's fingers would be far from the teeth of the chuck and key.

Thus, there is a need for a chuck key equipped with a hex bit connector, configured to facilitate manipulation of the chuck key via an impact driver or screwdriver equipped with a hex bit connector. Such an apparatus would expedite and simplify use of devices such as power drills in the exchange of bits on-the-fly, and help to prevent accidental loss of the chuck key.

### SUMMARY OF THE PRESENT INVENTION

The present invention is a linear chuck key equipped with a male chuck key on a first end and a male hex bit on a second end. The first end is disposed inline with the second end within the same primary axis.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 shows a view of the apparatus of the present invention as seen from the side, detailing the first end and second end of the present invention.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

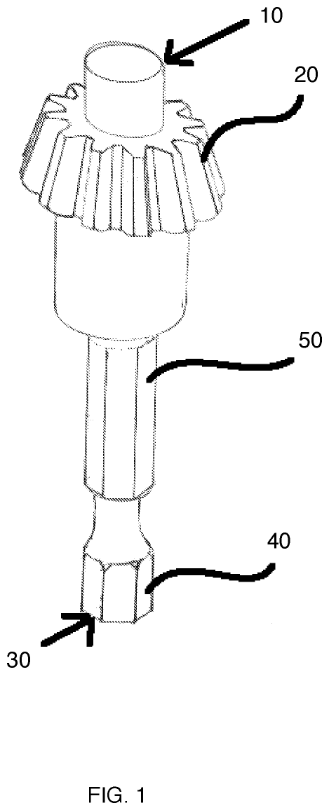

The present invention is a chuck key configured to manipulate the jaws of power tools such as drill presses and handheld drills which are equipped with a female chuck mechanism. The preferred embodiment of the present invention is equipped with a first end (10) equipped with a male chuck key (20), and a second end (30) equipped with a male hex bit (40). A hex-shaped shaft (50) is disposed in the same axis between the first end (10) and the second end (30) as shown in FIG. 1. The first end (10) and second end (30) are on opposite ends of the apparatus, and are inline within the same plane such that, when one end is turned, the second end is also turned at the same rate.

The second end (30) of the present invention is configured to be disposed in communication with a female hex bit holder conventionally found on impact drivers as well as some screwdrivers during use. It is preferred that the present invention be employed in conjunction with an impact driver to maximize torque, rather than a handheld screwdriver equipped with a ¼ ″ female hex bit receptacle. The first end (10) is configured to interface with a power tool equipped to accept the male chuck key (20) of the present invention which, when turned, can tighten or loosen the jaws of the tool to facilitate manipulation and/or exchange of drill bits.

The preferred embodiment of the present invention differs from other conventional chuck keys present on the market in that it has no handle by which a user could manually manipulate the key by hand. Instead, the present invention is disposed inline, within one axis, which facilitates more rapid use while using less energy to manipulate the key. The apparatus of the present invention is generally configured to be used in a ¼ ″ cordless electric impact driver, however it is envisioned that it could be disposed in communication with a handheld screwdriver instead. Further, the present invention is safer to use than a conventional T-shaped chuck key in that, when attached to an impact driver or screwdriver, the chuck key portion is farther away from the hand of the user, minimizing the chance of an accident or injury due to accidental activation of the drill during manipulation of the chuck. Likewise, use of the present invention speeds up production when constant drill bit changes are required, such as when oscillating between drilling pilot holes then drilling the final hole.

It should be understood that optimal use of the preferred embodiment of the present invention is in connection with a conventional, ¼ ″impact driver to achieve ideal torque to tighten the bit of the tool (drill press, etc.) via the chuck key (20) easily and quickly, preventing the slippage of drill bits. It is not necessarily advised to use the present invention in concert with a ¼ ″ hex screwdriver, as the ideal torque cannot be applied by hand without perpendicular leverage.

Further, it should be noted that the preferred overall length of the apparatus of the present invention is 2.75 inches long. The hex bit portion (second end (30)) is preferably 1.25 inches in length. In the preferred embodiment of the present invention, the apparatus is composed of alloy steel. Induction-hardened alloy steel is optimal for manufacturing the present invention. Some embodiments may be equipped with a magnet, however it is generally not necessary. A detent is present on the shaft of the second end (30) which ensures that the bit remains in position within the impact driver.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A tool apparatus comprising:
a first end, said first end equipped with a chuck key;
wherein said chuck key is equipped with teeth, said teeth circumscribing a cylindrical center which is raised above said teeth;
a second end, said second end equipped with a ¼ inch hex bit; and
wherein said second end is connected to said first end via a shaft.

2. The tool apparatus of claim 1, wherein said shaft is hexagonal.

3. The tool apparatus of claim 1, wherein said shaft is cylindrical.

4. The tool apparatus of claim 1, wherein said shaft is one inch in length.

5. The tool apparatus of claim 1, wherein said shaft is two inches in length.

6. The tool apparatus of claim 1, wherein said chuck key, said shaft, and said ¼ inch hex bit is composed of induction-hardened alloy steel.

7. The tool apparatus of claim 1, wherein the distance between said first end and said second end is 2.75 inches.

8. The tool apparatus of claim 2, wherein said shaft is one inch in length.

9. The tool apparatus of claim 2, wherein said chuck key, said shaft, and said ¼ inch hex bit is composed of induction-hardened alloy steel.

10. The tool apparatus of claim 2, wherein the distance between said first end and said second end is 2.75 inches.

11. The tool apparatus of claim 6, wherein the distance between said first end and said second end is 2.75 inches.
